(19) United States
(12) Patent Application Publication
(10) Pub. No.: US 2024/0427824 A1
(43) Pub. Date: Dec. 26, 2024

(54) Zyft A Decentralised Edge-based Search Engine for Products and Services

(71) Applicant: Zyft Holdings Pty Ltd, Elsternwick (AU)

(72) Inventors: Damien Michael Trevor Waller, Brighton (AU); Yuval Marom, Moorabbin (AU); Stevan Stojanovic, Hawthorne (AU); Gaurav Arora, Glen Huntly (AU); Jason Ellis, Spotswood (AU); Mohammad Samiullah Belal, Fawkner (AU)

(21) Appl. No.: 17/815,348

(22) Filed: Jul. 27, 2022

Related U.S. Application Data
(60) Provisional application No. 63/203,953, filed on Aug. 5, 2021.

(51) Int. Cl. G06F 16/953; G06F 40/295; G06V 30/10

(52) U.S. Cl. CPC G06F 16/953; G06F 16/951; G06F 40/295; G06V 30/10

(57) ABSTRACT

A system of determining information about items on a webpage uses a computer for analyzing items on the webpage to find matching products, and analyzes the items on the webpage which do not match to existing products, by identifying the product type of the items which do not match to the existing products, and locating and classifying predefined categories of the product type to train a named entity recognition model using elements of the predefined categories. The predefined categories can include title, price, brand, model number, and an attribute specific to the product type. For example, if the product type is a television, then the brands are known brands of the television, and the attribute is a size of the television. The named entity recognition model trains using a labeled data set to recognize other similar unknown brands based on the training.

This application claims priority from Provisional application No. 63/203,953, filed Jul. 29, 2021, the entire contents of which is herewith incorporated by reference.

### BACKGROUND

When viewing retail products on a website, there will be many similar products. Similar products often have pieces of information in common. Much of the time, the information about the product is stored in the metadata on the page.

However, the information is not always available in the metadata. Even if the information about the product is present, the information is not always accurate.

However, when it comes to product information, retailers tend to ensure the information visible to the user on their website is correct. The metadata accuracy is important for search engine optimisation (SEO) and is sometimes incomplete.

### SUMMARY OF THE INVENTION

The inventors recognized a number of drawbacks with the current systems.

Embodiments describe a system for running a decentralised search engine, with data extraction and processing provided by end-user's hardware via machine learning.

In an embodiment, the user installs the app/extension on their computing client, e.g., PC, Mobile or smart device. Data is gathered while the user browses the web.

Data is stored by users or hosted nodes on a decentralised network.

The embodiments, use Machine Learning (ML) to collect key pieces of information from product pages and store it for recompilation and analysis, rather than relying on metadata. This enables more accuracy in the extracted information.

### BRIEF DESCRIPTION OF THE DRAWINGS

In the Drawings:

The Figures show aspects of the invention, and specifically:

FIG. 1 shows a flow of extracting product information from webpage;

FIG. 2 shows an advanced flow of using a computer for extracting the fields using machine learning;

FIG. 3 shows a flow of named entity recognition operation;

FIG. 4 shows analyzing a page to find atomic units of information;

FIG. 5 shows the operation of analyzing the page using a state Mapper, model layers, and reward engine;

FIG. 6 shows an operation of an edged-based machine language;

FIG. 7 shows finding elements on a page; and

FIG. 8 shows an NLP matcher with shard operations.

### DETAILED DESCRIPTION

The present application describes a system that uses Machine Learning (ML) to collect key pieces of information from product pages and store it for recompilation and analysis, rather than just relying on metadata. This enables more accurate readings of the extracted information.

Some of the core attributes that are collected by the system, and stored from each site product may include, but are not limited to:
Title
Price
Availability
Product Image(s)
Brand
Canonical URL
UPC/EAN
Breadcrumbs
Description
Feature/specification tables

An embodiment stores the complete code, e.g., HTML, of each page. An embodiment forms a tree representation of the nodes, including their bounding boxes defining the geometry of the nodes.

An alternative embodiment uses a third-party data collection provider (eg Zyte) to provide data of this type.

In embodiments, a full screenshot of the product page is obtained. This can be obtained using Zyft Spiders, Zyft Provider Spiders or a Zyft browser extension, described herein.

Zyft spiders capture 100% of product pages as a full screenshot.

Zyte (provider) spiders capture 0% of product pages as a full screenshot.

Zyft browser extension captures 20% of product pages as a full screenshot. This percentage is configured by Zyft so can be varied.

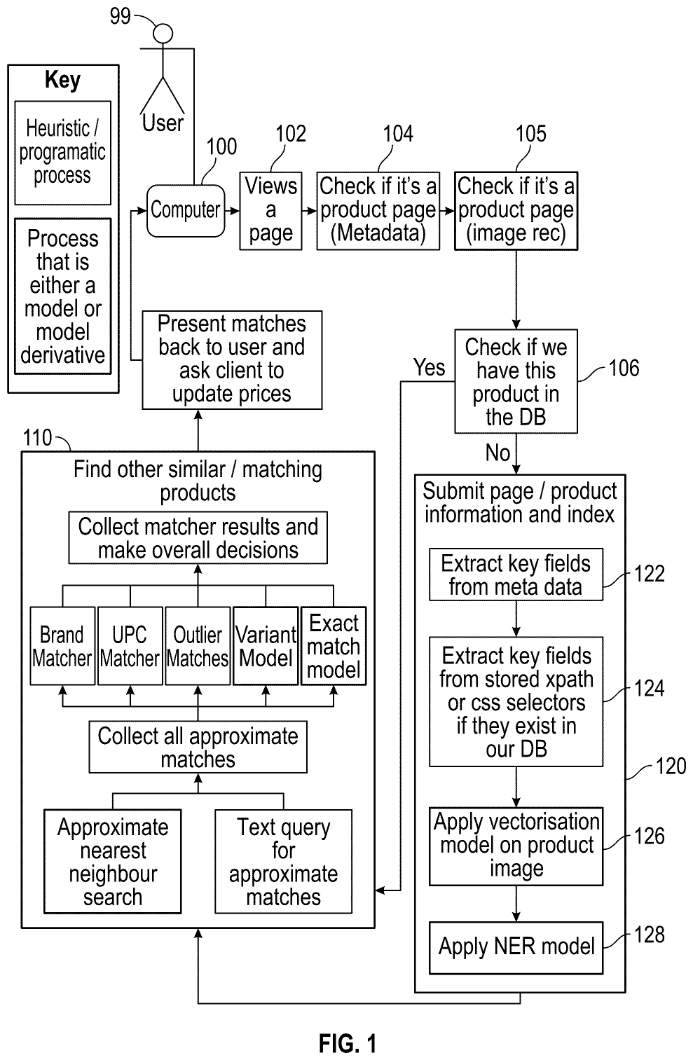

FIG. 1 shows a diagram of how users interact with ML. In FIG. 1, the flow is shown of a user 99, on a computer 100 which is running the software modules described herein, viewing a page at 102. The machine language system checks if the page being viewed is a product page using metadata at 104 and/or using image recognition at 105. At 106, the operation checks if the machine language-based system has the product in the database. If so, flow passes to the match box 110 to find nearest neighbor, approximate matches, and other previously cached match connections that link to the aforementioned product, and to try to find other similar matching products, to provide additional matches to the user.

If the product is not in the database at 106, then flow passes to a submit box 120, in which key fields are extracted from the metadata at 122, to determine at 124 if this kind of metadata exists in the database. The product is inserted into the database as a new product. This can apply a vectorization model on the product image and vectorization embedding models on the text of the product at 126 and apply another model at 128 in attempt to find similar products.

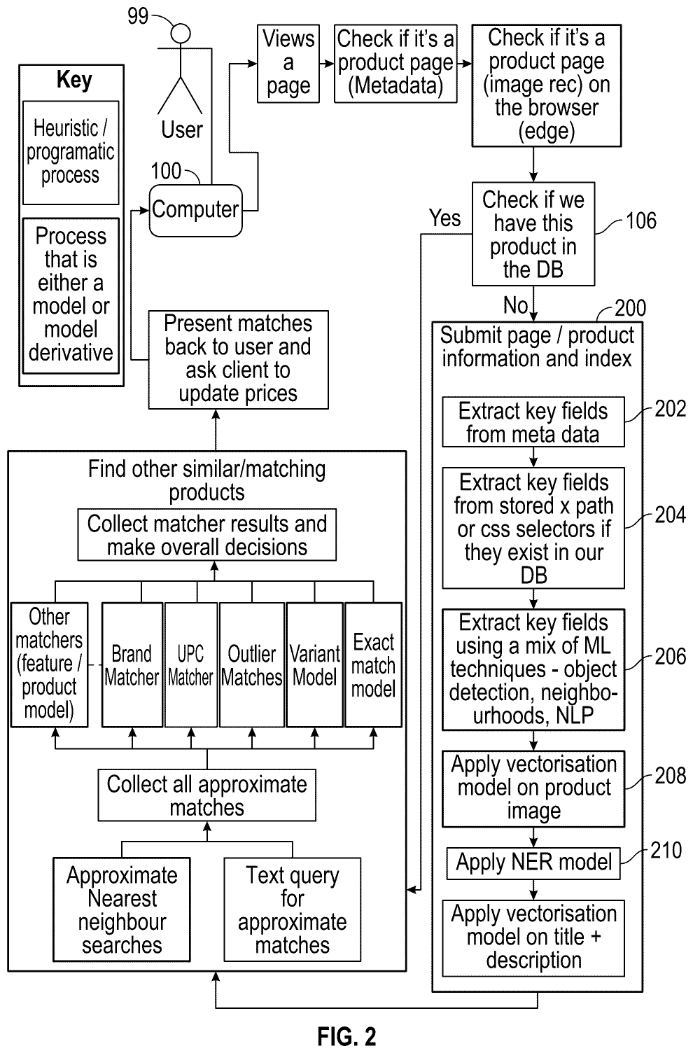

FIG. 2 illustrates an embodiment, showing the advanced way that the users interact with the models. In the FIG. 2 embodiment, when no matching product is found in the database at 106, an advanced submit operation is carried out. In this operation, key fields are extracted from the metadata at 202 and from stored paths at 204. The fields are extracted at 206 using a mix of machine language techniques including object detection, neighborhood detection and NLP to find similar results. The product image is vectorized at 208.

At 210, Named Entity Recognition (NER) is carried out on the text nodes of the page. Named Entity Recognition, or NER, is a subtask of information extraction that seeks to locate and classify named entities mentioned in unstructured text into pre-defined categories including title, price, and technical specifications.

NER can be trained over large, labelled data sets to extract a pattern in the text and can be used for finding other similar brands using the techniques.

Training data for NER looks like this:

| Brand 1 | Sceen_Size 2 | | Model_NUM 3 |
|---|---|---|---|
| Sony^{Brand} | A9G^{Model}_NUM | 77\ | Master Series 4K |
| | | ″^{Sceen}_Size | UHD Android |
| | | | OLED TV |

Tagging sentences/titles of products with these tags is a laborious and expensive task. NER typically requires many training sentences tagged to predict anything meaningful.

An embodiment uses a self-supervised mechanism to tag sentences based on already known attributes.

Titles are used to extract information such as brand and model number, from the retailer's structured information. An example of which is:
title: Sony A9G 77″ Master Series 4K UHD Android OLED TV
Brand: Sony
Model_NUM: A9G
Screen_Size: 77″

Here, the attribute screen size is specific to the product type, here a TV.

The system then uses values of these model numbers, along with one or more of the other attributes, to automatically tag titles in a format that is used for NER training.

A specialised trie based method is used to efficiently tag titles based on all the known values for the attributes. A naive method to check if any of the possible values of brand exist in the title is very time consuming. According to an embodiment, a tries based structure is used to tag a sentence to make the tagging process linear in length of sentence.

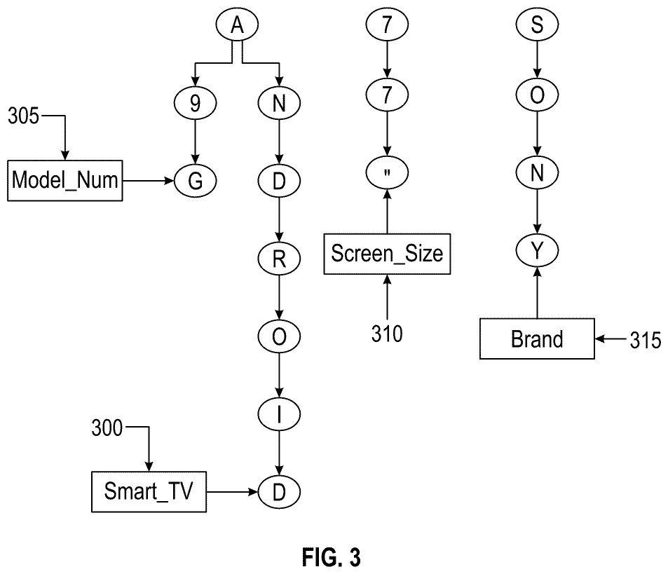

A representation of tries based structure used is shown in FIG. 3, using the example shown above. This can be used to extract from the metadata, for the example of of an appliance, the type of appliance (smart TV at 300, from the word “android” in the metadata), the model number 305, screen size 310 and brand 315. This data is recognized by matching to known information about products, and once recognized, is then used as training data to train a NER model which is resistant to noise introduced by automatically tagging the titles using possible values for attributes.

Object Detection can also be carried out via a full screenshot or many screenshots of the page at different scroll positions and viewports. Object Detection as used herein is a computer vision technique that enables identifying and locating objects in an image. Object Detection, once used, can detect objects on a page and determine and track locations of those objects while also accurately labelling them. This helps detect the product image, title, and price and other attributes.

Optical Character Recognition (OCR) can allow using results of the Object Detection to extract specific values of a recognised object. OCR as used herein is the electronic conversion of images of typed, handwritten or printed text on the page into machine-encoded text. This helps identify the actual title or price as a text string.

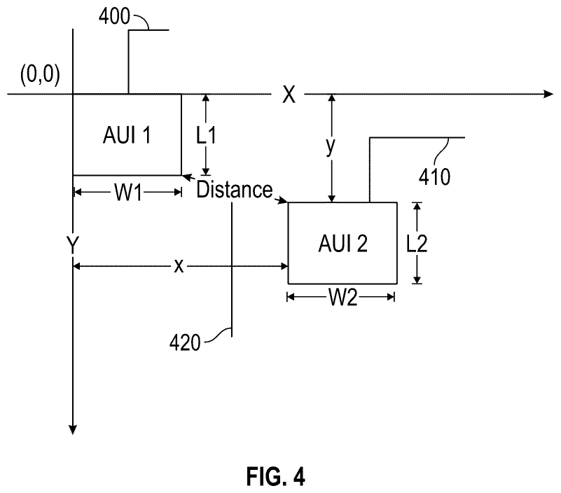

Atomic Units of Information (AUI) are described as shown in FIG. 4. In one embodiment, the AUIs are rows in the database, which were collected and annotated using human annotators. They are a key component of our data foundation used in identifying key data attributes or features of a page.

AUIs break a webpage into the constituent atomic units of information within it, for example, the question that asks for “gender” to be entered, or the section that shows a product feature.

AUI-based-approaches are used to first attempt to decompose the page into AUIs. Standard classification techniques are applied to classify highly confident AUIs. For example, this can be used for identifying prices and titles and classifying them into known entities.

Geometric ‘neighbour’ based detection methods are used based on neighbourhoods of highly confident attributes. Geometric ‘neighbour’ based detection methods as used herein operate where the results of either Object Detection or NER are used and allow a machine to pay attention to the geometric properties of those pieces of information. Unsupervised machine learning methods (e.g. k-means clustering) enable identification of patterns of ‘neighbouring features’. For example, on retail sites, the price of an item is usually located to the right of, or below the title of an item, and is usually in close proximity to the product title or image, compared to the proximity to the product's technical specifications.

When a page is indexed, the geometry of the desired information is extracted including price, title, image, and other information. The coordinates of the specific information on the page and the bounding box around them are determined using this information. Object Detection is used to train a vision model by showing them the geometry, and that vision model can then infer where other similar features are located on the page.

According to an embodiment, these techniques use relative spatial signals to identify products and are extended to provide some weighting of where certain features might be.

Neighbourhood methods work when AUIs are detected on the page, either via traversing the document or by using Object Detection on the image of the page.

Constructing AUI Coordinate Spaces is used to determine suitable ‘AUI Neighbourhoods’. FIG. 4 shows a recognized AUI1 400 being located in the coordinate system at location 0,0. The AUI1 has an extent of a first width w1 and a second length L1. The AUI1 is spaced from a recognized AUI to number 410 will which itself has a width w2 and length L2. The AUI 2, 410, is located at a position x,y which is spaced from the AUI1, by a distance 420 which can be determined for example using a geometrical breakdown of the page. The distance between different recognized AUIs is measured and used to group product features into products.

From an intuitive point of view, a relative measure of ‘distance’ is image/screen based distance based which relies on a normal aspect ratio from a customer's point of view. This easily applies to the ‘neighbourhood’ problem and ‘product grouping’ problem since AUIs that are related are expected to be spatially close together.

The distance measure uses a local coordinate system between the AUIs. In the embodiment with two separate AUIs, a local coordinate system (up to isometry) is as diagrammed in FIG. 4.

These local coordinate patches can be used to fill in a distance matrix defined as follows:

D_{i,j}=distance(AUIᵢ, AUIⱼ)

Where the distance between AUIs is the ‘geometric’ distance between AUI bounding boxes as they exist in the same local coordinate patch, or the ‘maximum’ distance otherwise.

Note that this only becomes well defined if the same AUIs are ‘detected’ in the same coordinate patch.

### Vector Matrix/Tensor

As similar to the distance matrix above, a ‘vector matrix’ (or vector tensor) is used, defined as follows:

$${V}_{i , j , k} = {( \vec{P} ( {AUI}_{i} ) - \vec{P} ( {AUI}_{j} ) )}_{k}$$

where the ‘P’ function denotes the position of the AUI in a local coordinate space. This can be thought of as a matrix which describes a vector between one AUI and another.

In one embodiment, a global coordinate space has the positions (and sizes) of all AUIs in the same ‘page’ in one section. In this way, a well-defined distance matrix can be constructed as in the ‘vector matrix’ above.

This can be constructed using several methods.

Method 1: Patching together the local coordinate spaces to create an Atlas which can be used to define global coordinates.

Method 1 can be achieved in two ways:
Use an Image Templating approach—detecting smaller images that belong to a larger image.
Use a Full Page Stitching approach—in an embodiment, creating a panorama photo where individual images are stitched into a larger coherent image.

Method 2: Storing all the AUIs in one screenshot.

Method 3: Scoring all the scroll data of each AUI when captured.

### AUI Neighbourhoods (Coordinate Based)

These techniques can be developed further to distinguish the main ‘product’ from product recommendations on a singular page: Product Generation via Price Anchoring, especially as price is usually an extremely clear signal and can be used as an ‘anchor’ to, or in conjunction with neighbourhoods to find products.

Techniques around determining all products present on a page and the relative size and vertical positioning of price/title AUIs can be used to determine other features by processes of elimination.

In an embodiment:

Assume in one neighbourhood the price and title have already been detected with a high level of confidence.

Several other fields remain that have some level of confidence around being a title, a breadcrumb or description.

Since we know they definitely cannot be a title, use Bayes Theorem to remap probabilities to the other possible entries.

This is an adjusted level of confidence for each of the previously ‘semi-identified’ parts.

Smart Crawling is another naive approach to crawling sites more efficiently. This can be carried out by building propensity models that approximate a probability that any given link found on a page yields a product page. These models are then used to sort the list of available links on a site in order to increase the proportion of ‘early’ links navigated to yield a product page.

Reinforcement learning techniques can be applied where an agent has a set of links it can follow and attempt to maximise a long-term reward (which it gets by finding ‘new’ product pages).

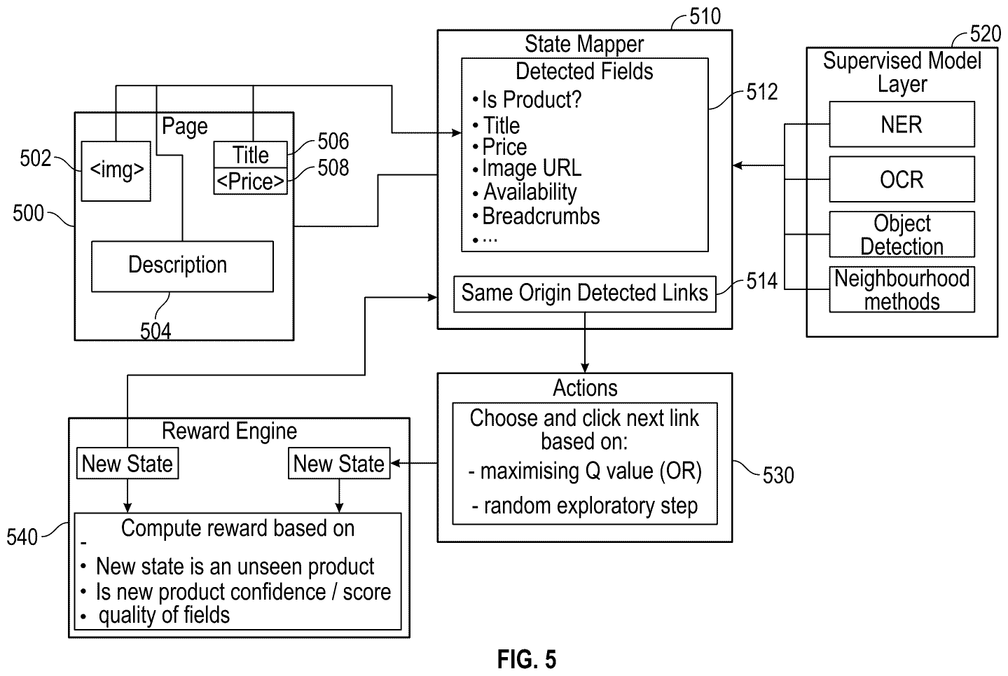

FIG. 5 shows a diagram showing an embodiment of a reinforcement learning-based crawler. In FIG. 5, the page being analyzed, has an image 502, description 504, title 506 and price 508. These different fields are analyzed using a
State Mapper 510,
Supervised Model Layer 520,
Actions layer 530, and a
Reward Engine 540.

The State Mapper 510 operates to convert a currently viewed page and mapping out a view of the ‘state’ of the page based on the Supervised Model Layer 520.

This is useful for simplifying the Q-learning process since just providing the full HTML and Image of the page as input may need a lot more initial exploration before a good signal is detected and is somewhat synonymous to modelling the problem as a Partially Observable Markov Decision Process (POMDP).

It also helps model a suitable reward in the Reward Engine 540 (see below).

The State Mapper looks for key fields at 512, including but not limited to:
title
price
product image.

Additionally, all links are extracted and sent to a growing set of available links using the detected links block 514 the detected links are sent to the actions block 530.

The Supervised Model Layer 520 operates to break down the page into key fields into AUIs, or otherwise.

The Actions at 530 in this model will involve clicking one of the available links collected via the State Mapper. There is usually a decision here:
Exploit: maximise the approximate Q function, which attempts to model decayed long term reward.
Explore: Either randomly or otherwise (e.g., a systematic method based on sample sizes) choose an alternative action that is not detected as maximal as there may not be enough examples of going down a different ‘path’ at a given time.

The Reward Engine 540 is responsible for the Q function (delayed long-term reward) and, therefore, the behaviour of the Reinforcement Learning (RL) agent as it crawls through a website. The Reward Engine will look at the quality of the ‘new state’ and compare it to the previous ‘state’ of the system. This can include:
The confidence that the new page is a product page;
How many more links were generated;
The quality of the mappings.

A good Reward Engine, alongside good quality signals coming from the State Mapper and Supervised Model Layer, leads to an efficient crawl of a site.

Zyft models look at different content types such as images, and titles, and extracted features from product pages to identify if two product pages are a match or not.

The comparison based on automatically extracted features leads to a major boost in matching performance and is different from other approaches. Most other approaches rely on comparing features extracted using named entity recognition. Our method avoids the pitfalls of aligning features i.e. NER feature matching model comparing 16 GB disk space on a mobile phone with 16 GB ram on a laptop.

Visual Attention mechanism can be used to cope with image quality issues. In operation, it was found that the models were ignoring signals from images due to bad images from retailers. Visual attention is used to attune the signal from images where the image is either low quality or a generic image.

Another aspect described herein is that of Compressed Models.

Our trained models are huge going up to 500M parameters. We invented a custom temperature annealing schedule for knowledge distillation which leads to 1.5 times improvements in transferring knowledge from a larger model to a smaller model of 13M parameters.

This custom temperature annealing schedule improves performance on edge-based machine learning setup as well.

### Image Enhancement Schemes for Comparing Products

Most retailers have different sizes and aspect ratios for product images. We enhance the images using custom transformations including SquarePadding and identifying the main part of the product to crop the surrounding white space. We also use various transformations to improve the performance of these models.

We use auto-encoder based Machine Learning models to compress large image files into a vector of 256 dimensions. We can regenerate the same image using these vectors. We do further processing using this 256-dimensional vector, as it saves us time fetching large images from the file system.

The machine language crawl uses machine learning-based comparison and matching of products and product features, differentiating between exact and approximate matches.

Feature extraction and normalisation using an NER model and rule-based approach to extracting features.

Using Deep learning techniques (on both the titles and product images) to create vectors for each unique product in an Approximate Nearest Neighbourhood vector database. Get the closest neighbour from the representation of a new product to generate possible product matches using an appropriate distance metric (e.g., cosine similarity).

Match images based on similarity using already trained Neural Nets to extract abstract “Features”. With these feature vectors, a cosine similarity between images can be used to see whether it is suitable for such a similarity measure.

Reinforcement learning-based ‘auto research’ for products to see what the ‘best product’ in the market is based on the needs of the users.

Reinforcement learning differs from supervised learning in that it does not need labelled input/output pairs to be presented, and it does not need sub-optimal actions to be explicitly corrected. Instead, the focus is on finding a balance between exploration (of uncharted territory) and exploitation (of current knowledge).

That can be modelled via a Markov Decision Process (MDP) of a single agent as follows:
The state of the system is a mix of the current product and ordered collected competing products.

The actions in this system could include the following:
Actions to search for another product (either via the web or through a database);
Actions to insert, delete or provide a transposition in the ordered collection of competing products.

Rewards in this system would be a mix of relevancy score of the ordered collection of competing products and weights of ‘goodness of features’ (e.g. higher resolution could indicate a positive weighting toward the top) with possible human feedback.

Machine learning runs on end-user hardware (Edge ML).

Edge ML as used herein is a technique by which Smart Devices can process data locally (either using local servers or at the device level) using machine and deep learning algorithms, reducing reliance on Cloud networks. The term Edge ML refers to processing that occurs at the device-or local-level (and closest to the components collecting the data) by deep-and-machine-learning algorithms.

This has the advantage of reducing server load since the inference is typically done on the end-user's machine, and increasing privacy since data typically only needs to be processed locally and not sent to another external service. It can also prevent sending of information which could otherwise be intercepted by a bad actor.

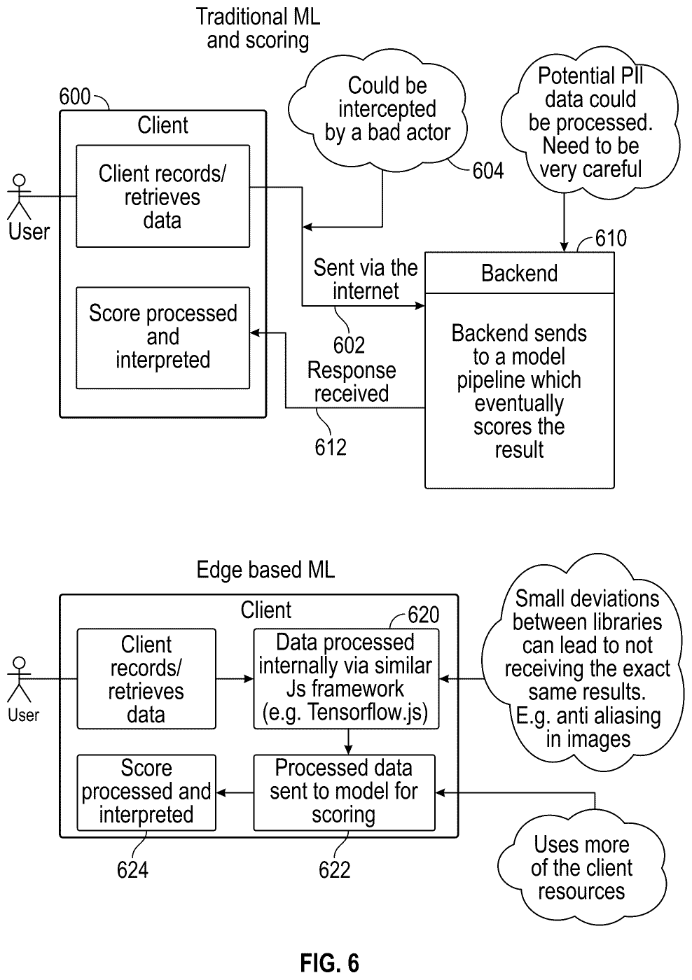

FIG. 6 shows the traditional machine language at the top, in which the client 600 sends the data 602 over the Internet where it could be intercepted at 604. The data is sent to a backend's 610 which scores the result and sends a response at 612 back to the client. The edge-based machine language, shown at the bottom part of FIG. 6, processes the data internally at 620 the process data at 622 is then sent back to the metal model for scoring at 624.

Indexing and Data Storage is carried out by Zyft users capture relevant data automatically in a background process when browsing the web via machine learning. This machine learning is used to help extract and process data in order to index any detected products.

Symmetric embedding machine learning models are trained to provide embeddings based on the processed user data. These embeddings generally coincide with a sense of semantic similarity for the given domain and have a finite dimensional vector space representation. This is part of the indexing of product/web data.

A Zyft user's indexed content is sent and stored across provider data shards.

A shard is a horizontal partition of data in a database or search engine. Each shard is held on a separate database server instance to spread the load and improve recalling the data related to a product. Some data within a database remains present in all shards, but some appear only in a single shard.

All data is running on a federated or peer-to-peer decentralised network.

On this decentralised network, the embeddings collected earlier are used for approximate (high recall) search, and nodes on each machine can determine N ‘closest’ embeddings from any given ‘search’ term embedding. They can then vote for the total overall closest embeddings.

A federated database system is a type of meta-database management system, which transparently maps multiple autonomous database systems into a single federated database. The constituent databases are interconnected via a computer network and may be geographically decentralised.

### Anti-Bot Bypass Solutions

Anti-bot solutions follow a real-time approach when it comes to blocking bots. They use robust algorithms to detect, analyse and categorise bot patterns and bot signatures.

Zyft's scraping process cannot be blocked by existing anti-bot methods due to running on end-user hardware. This works because a portion of the data collection is not done via a robot, but rather by organic users viewing novel content.

### Apps/Clients

The client application can run on a wide range of hardware, e.g., mobile phones up to 3 years old to high-end desktop PCs.

Various clients will be available but not limited to:
Chrome, Safari and Firefox browser extensions,
Desktop Clients (PC, Mac),
Progress Web Apps,
iOS, Android Apps,
Smart Speakers and Smart Glasses.

Installed clients will have the ability to auto-purchase online goods (at the set strike price), using an automated bot that completes checkout for the user with pre-saved profile and payment details.

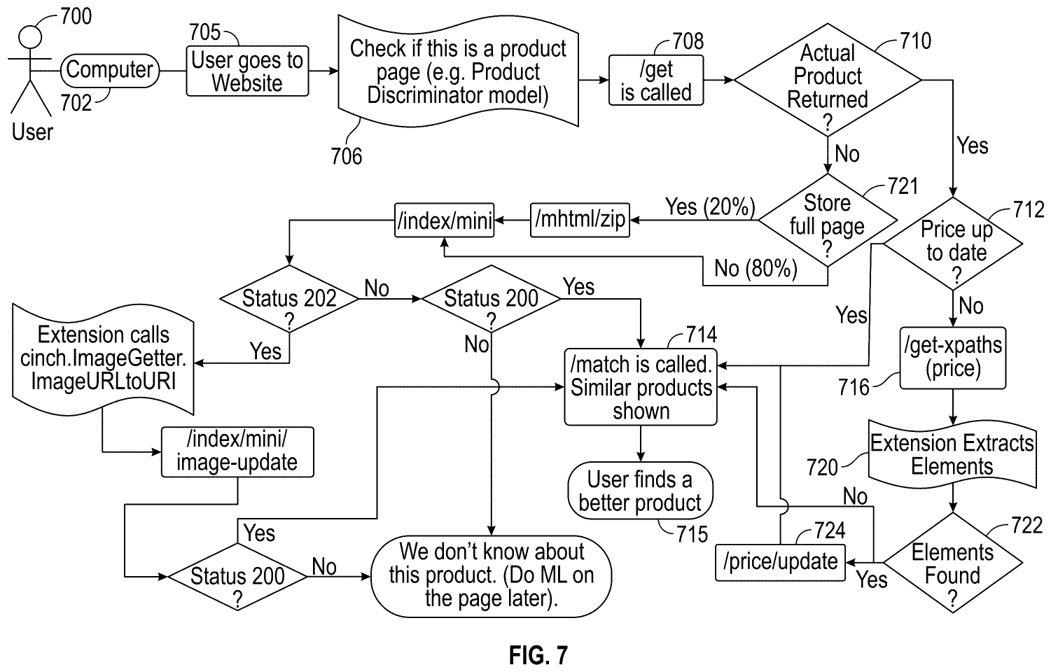

The system operates according to the flow diagram of FIG. 7. In FIG. 7, the user 700 operates a computer 702 to carry out the functions described therein. The user goes to a website at 705, and uses the computer to operate a product discriminator model to determine if the current page is a product page at 706. If so,/get is called at 708 and a determination is made as to whether the actual product has been returned at 710. If an actual product is returned at 710, 712 determines if the price is up-to-date. If so, the match function is called, and similar products are shown. The user might find a better product at 715.

If the price is not up-to-date, the/get xpaths function is called at 716, to get the price by extracting elements at 720. If the elements are found at 722, the price is updated at 724, and flow passes to the match routine.

If an actual product is not returned at 710, then a determination is made as to whether to store the full-page at 721. The storage is then carried out according to the amount of storage requested. This is compared with other products to determine again the better product can be found.

Results are presented in order of price, relevance, or based on a recommendation engine.

Users can search by a wide range of attributes including but not limited to keyword, UPC, brand, manufacture, reverse image lookup, barcode and price range.

Search results can be subscribed to for automatic updates when results change, i.e. new product, price change.

Searching using the matchers can be computationally expensive. We can mitigate this computation overhead using a knowledge graph where nodes represent site products and edges represent any knowledge on how well these two nodes match.

In this representation, an edge between two nodes represents an approximate match between two site products, and these edges contain ‘weighting’ information which include:
matchers
For each matcher
Matcher version
Matcher score for these nodes

This way, after repeated approximate searches, as long as the matcher versions on the edges are the same, we can simply retrieve this information from the graph rather than use a model to repeat the same matcher scores. Otherwise, if matcher versions are not the same, we use the machine learning based matchers and make updates to these edges.

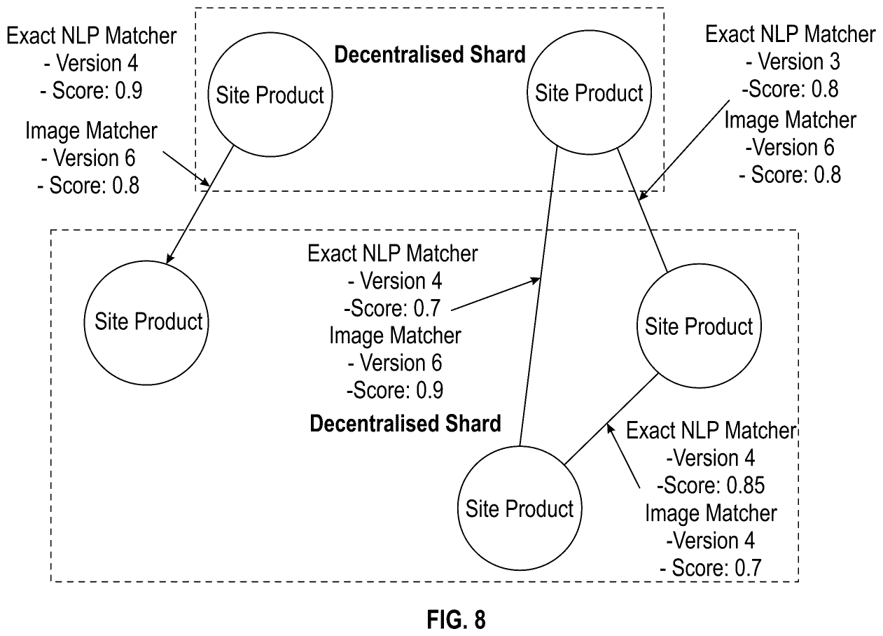

FIG. 8 illustrates a section of this graph with example matcher versions and scores for an NLP matcher. Here one decentralised shard holds data of two nodes of the graph and the corresponding edges and another holds three nodes and corresponding edges. Both shards contain the same information about three edges in the example.

Assuming matcher scores are highly accurate, connected components of this graph correspond to a first order set of products which can be used for other search features down the track. The connected components also help with higher recall on product matches due to transitivity of match results (e.g., if A matches with B and B matches with C, then A should match with C).

Users can authenticate via existing social networks and OAuth.

Users can subscribe to brands, new products, product updates, including price monitoring and recommendations with push notifications to existing social channels.

Users can share their results via social networks or by any other sharing mechanism.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system of determining information about items on a webpage, comprising:
a computer, operating for analyzing items on the webpage to find matching products;
analyzing the items on the webpage which do not match to existing products, by identifying the product type of the items which do not match to the existing products, and locating and classifying predefined categories of the product type to train a named entity recognition model using elements of the predefined categories.

2. The system as in claim 1, wherein the predefined categories include title, price, brand, model number, and an attribute specific to the product type.

3. The system as in claim 2, wherein the product type is a television, and the brands are known brands of the television, and the attribute is a size of the television.

4. The system as in claim 1, wherein the named entity recognition model trains using a labeled data set to recognize other similar unknown brands based on the training.

5. The system as in claim 1, where metadata on the webpage is analyzed to find keywords in the metadata.

6. The system as in claim 1, further comprising detecting objects in an image of the webpage and recognizing characters in the image to extract specific values as text strings.

7. The system as in claim 1, further comprising detecting atomic units of information AUIs in the webpage to identify prices and titles in the webpage, as highly confident attributes in the webpage.

8. The system as in claim 7, wherein the highly confident attributes are grouped into geometric neighbor-based detection groups to find additional aspects in the webpage.

9. The system as in claim 8, wherein the geometric neighbors are used as training elements to train a vision model.

10. The system as in claim 7, wherein different AUIs are measured and used to group product features into grouped products.

11. The system as in claim 7, where fields that are measurable with confidence based on known parameters represent the atomic units of information.

12. The system as in claim 7 where the price and title of the objects represent the atomic units of information.

13. The system as in claim 1, further comprising forming a propensity models that approximates the probability that any given link found on a page yields a product page and using the propensity model to train the system to find new product pages.

14. The system as in claim 1, wherein the computer system obtains a page to be analyzed, and analyzes the page using a state Mapper that looks for key fields in the page including the known fields, and uses a supervised model layer which breaks down the key fields into atomic units of information to automatically extract features from the page by comparing the content types of the page with known content types to determine a match, and a reward engine, which determines a confidence in quality of the mapping, to determine if the site has been efficiently crawled.

15. Combination of visual attention and SquarePad transformation and auto-encoder techniques for image models can help cope with bad quality images from real-world retailers.

16. A Knowledge Graph (as shown in FIG. 8) with Graph-based neural network techniques can improve product matching despite bad quality data from retailers.

17. Our customized temperature annealing technique can achieve model compression while preserving the same accuracy for matches.

18. Modifications of state of the art NLP neural models allow us to ensure key mathematical relations between documents including the ‘symmetric’ property which improves scores of our models.
